(19) United States
(12) Patent Application Publication
(10) Pub. No.: US 2012/0114994 A1
(43) Pub. Date: May 10, 2012

(54) ELECTRICAL CELL

(75) Inventor: Tomoyoshi Kurahashi, Tokyo (JP)

(73) Assignee: MITSUBISHI HEAVY INDUSTRIES, LTD., Tokyo (JP)

(21) Appl. No.: 13/290,625

(22) Filed: Nov. 7, 2011

(30) Foreign Application Priority Data
Nov. 9, 2010 (JP) 2010-251127

(51) Int. Cl. H01M 10/48

(52) U.S. Cl. 429/90

(57) ABSTRACT

An electrical cell includes a first battery block including a first stacked electrode body formed by stacking a positive electrode plate and a negative electrode plate through a separator and a first spacer arranged on the first stacked electrode body; a second battery block that including a second stacked electrode body formed by stacking a positive electrode plate and a negative electrode plate through a separator and a second spacer arranged on the second stacked electrode body; a battery case containing the first battery block and the second battery block to contact the first spacer and the second spacer; and a sensor, wherein the sensor is arranged in a sensor arrangement region formed between the first spacer and the second spacer.

### BACKGROUND OF THE INVENTION

1. Field of the Invention

The present invention relates to an electrical cell with a sensor.

Priority is claimed on Japanese Patent Application No. 2010-251127, filed on Nov. 9, 2010, the content of which is incorporated herein by reference.

2. Description of Related Art

A battery includes a primary battery that may be only discharged and a secondary battery that may be both charged and discharged. It is known that the battery generates heat by being used. When the temperature of the battery increases due to the heating, there is a possibility that the battery may not provide superior performance. For this reason, there has been an attempt to maintain the performance of the battery by arranging a temperature sensor near a battery unit, that is, an electrical cell so as to measure the battery temperature of the electrical cell and by cooling of the battery appropriately (refer to Japanese Patent Application Laid-Open Nos. 2004-14171 and 2006-4911).

However, as in the related art, when the temperature sensor is arranged outside the battery case even when it is close thereto, it is difficult to accurately detect the temperature inside the electrical cell which is being heated. Therefore, the related art requires complex cooling control or the like for maintaining satisfactory performance of the battery. On the other hand, when the temperature sensor is arranged into the electrical cell without careful consideration, for example, the temperature sensor is arranged into the battery case with contacting an electrode plate, there is concern in that the electrode plate may be deformed or damaged and the performance of the battery may be degraded despite.

### SUMMARY OF THE INVENTION

The invention is made in view of such circumstances, and it is an object of the invention to provide an electrical cell capable of having satisfactory battery performance with a sensor installed therein.

According to an aspect of the invention, an electrical cell includes: a first battery block including a first stacked electrode body formed by stacking a positive electrode plate and a negative electrode plate through a separator and a first spacer arranged on the first stacked electrode body; a second battery block including a second stacked electrode body formed by stacking a positive electrode plate and a negative electrode plate through a separator and a second spacer arranged on the second stacked electrode body; a battery case containing the first battery block and the second battery block to contact the first spacer and the second spacer; and a sensor, wherein the sensor is arranged in a sensor arrangement region formed between the first spacer and the second spacer.

In the electrical cell, because the sensor is arranged in the sensor arrangement region formed between the first spacer of the first battery block and the second spacer of the second battery block, it is possible to suppress damages or deformations of the electrode plates forming the stacked electrode body.

According to the aspect of the invention, an electrical cell which has satisfactory battery performance with a sensor installed therein may be provided.

### BRIEF DESCRIPTION OF THE DRAWINGS

FIG. 1 illustrates an exploded view of an electrical cell of a first embodiment.

FIG. 2 illustrates a cross-sectional view with taken along the line A-A′ of FIG. 1.

FIG. 3 illustrates a cross-sectional view with taken along the line B-B′ of FIG. 1.

FIG. 4 illustrates a detailed schematic view of a second battery block in FIG. 1.

FIG. 5(a) illustrates a plan view of a modified example of a spacer in FIG. 1, and FIG. 5(b) illustrates a cross-sectional view of the modified example.

FIG. 6 illustrates a cross-sectional view of an electrical cell of a second embodiment.

### DETAILED DESCRIPTION OF THE INVENTION

Hereinafter, exemplary embodiments of the invention will be described by referring to the drawings. In the drawings, the dimension or the scale of the components in the drawings may be different from those of the real components in order to easily explain characteristic points. The same reference numerals are given to the same components of the embodiments, and the detailed description thereof will not be repeated.

### First Embodiment

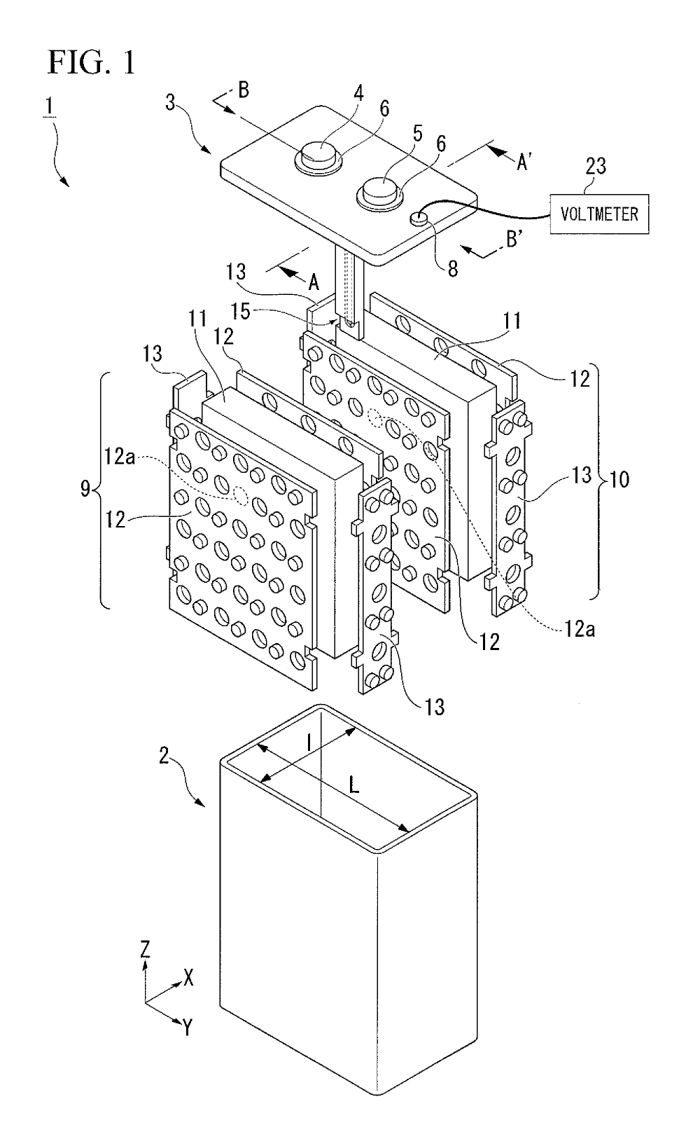

FIG. 1 illustrates an exploded view of an electrical cell of a first embodiment. The electrical cell 1 in FIG. 1 is, for example, a lithium ion secondary battery cell having a parallelepiped case.

The electrical cell of the first embodiment includes a plurality of battery blocks inserted into a battery case, that are described later, a sensor arranged between the plurality of battery blocks, and a cover having an electrode terminal, and the battery case sealed by the cover (an electrolyte is also stored inside the battery case). Hereinafter, the invention will be specifically described by referring to FIGS. 1 to 4. In all FIGS. 1 to 4, the same orthogonal coordinate system is used.

As illustrated in FIG. 1, a battery case 2 has a parallelepiped shape as described above. That is, the battery case 2 includes a substantially rectangular bottom surface having a long side (length “L”), along the Y direction and a short side (length “l”)along the X direction, and includes wall surfaces connected to all sides of the bottom surface and extending to a direction (i.e., ±Z direction) perpendicular to the bottom surface.

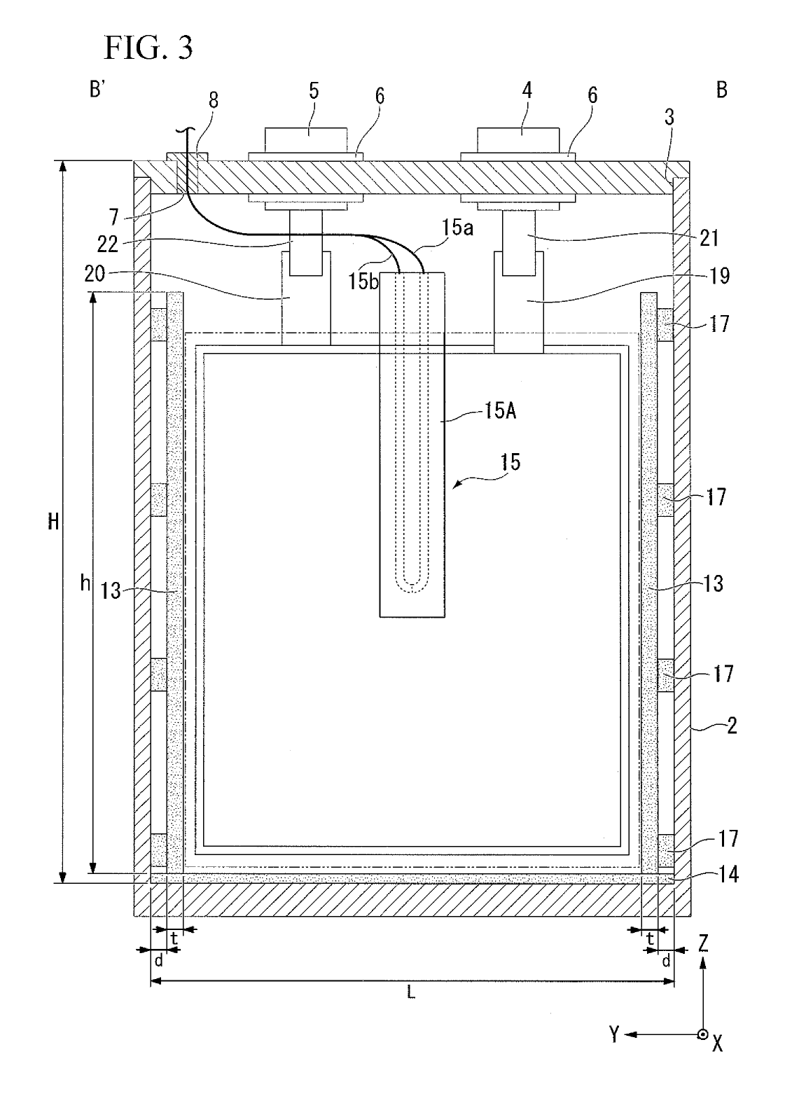

A cover 3 is formed in a plate shape which is substantially the same as that of the bottom surface of the battery case 2, and an electrode terminal (i.e., a positive electrode terminal 4 or a negative electrode terminal 5) is fixed to and passed through the cover. Further, a liquid injecting hole 7 (see FIG. 3) is also formed in the cover so as to inject an electrolyte into the battery case. The battery case 2 and the cover 3 may be formed of an insulating plastic resin of which the property is not changed by the electrolyte or the like, or may be formed of conductive metal such as aluminum. When the battery case and the cover are formed of the same material, the battery case 2 and the cover 3 may be connected to each other by welding, adhering or thermal bonding in order that a gap between them is effectively sealed. When the battery case and the cover are formed of a conductive material, as shown in FIG. 1, an insulating member 6 such as a plastic resin is formed between the electrode terminal and the cover 3 in order that the electrode terminal is not electrically connected to the cover 3.

As to the liquid injecting hole 7, it is not buried during the sealing. Therefore, the battery cell is not airtight perfectly in a strict sense. After a step of the sealing, an electrolyte (not shown) is injected from the liquid injecting hole 7, and the liquid injecting hole 7 is blocked by a sealing member 8 such as a screw for the battery cell to be airtight substantially. In order to seal the battery cell tightly, it is desirable that the material of the sealing member 8 is the same as that of the cover 3.

At least two battery blocks are installed into the battery case 2. FIG. 1 illustrates two battery blocks, that is, a first battery block 9 and a second battery block 10. The first battery block 9 and the second battery block 10 have the same structure for manufacturing them easily, and are distinguished as “first” and “second” for convenience of description.

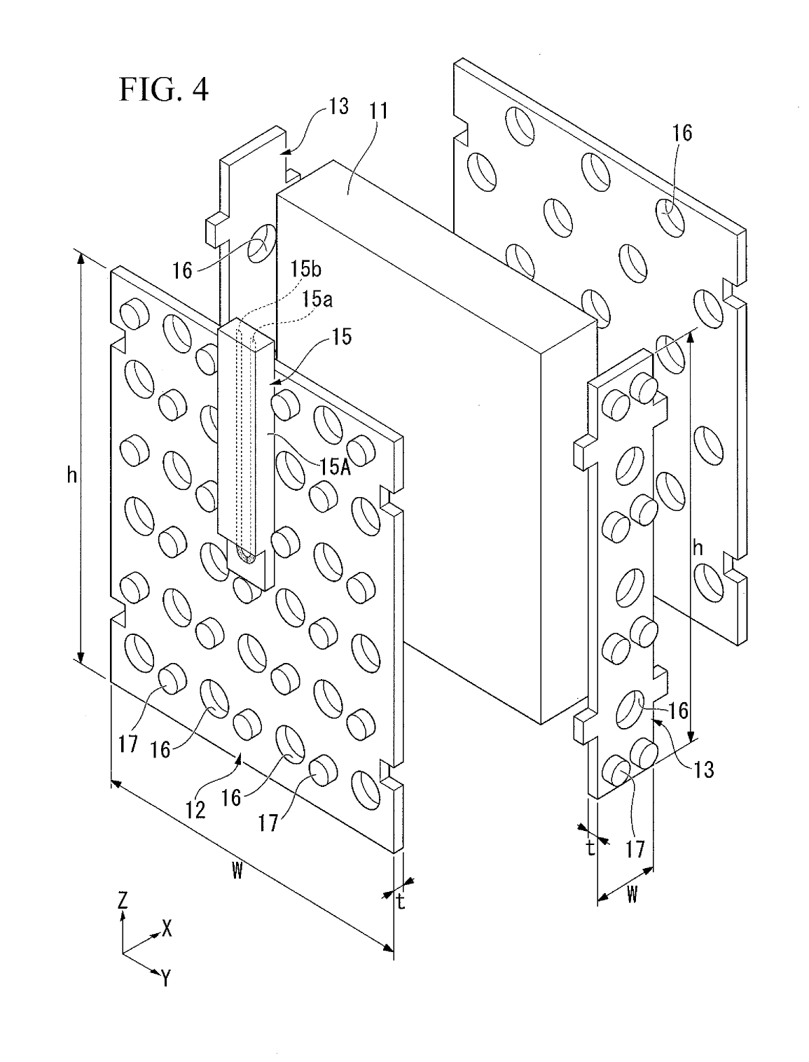

In this manner, because any battery block has the same structure, the second battery block 10 will be here described by referring to FIG. 4 in order to specifically describe one battery block.

The battery block includes: a stacked electrode body 11 which is formed by stacking a positive electrode plate and a negative electrode plate with a separator interposed between them, and a spacer which is formed of a resin (e.g., an insulating plastic resin) in a shape surrounding the stacked electrode body 11. FIG. 4 illustrates two first spacer members 12 with a rectangular plate shape substantially having a width “W”, a height “h”, and a thickness “t” and two second spacer members 13 with a rectangular plate shape substantially having a width “w”, a height “h”, and a thickness “t” (here, W>w).

Through holes 16 are formed in the first spacer members 12 and the second spacer members 13, that pass through the members in order to make satisfactory permeation of an electrolyte into the stacked electrode body 11 (it is desirable that a plurality of through-holes be provided in order to make effective permeation of the electrolyte). Through-holes 16 are formed at a position where the arrangement of convex portions 17 is not disturbed. Further, the plurality of convex portions 17 (with a height “d”) is formed in the first spacer members 12 and the second spacer members 13 in a protrudent shape so as to protect the stacked electrode body 11 from a vibration or the like of the electrical cell 1. Convex portions 17 may be formed by pressing the first spacer member 12 and the second spacer member 13 from the rear surfaces thereof and changing the shape (in FIG. 4, regarding all the first spacer members 12 and the second spacer members 13, one surface, of which the convex portion 17 is formed, is referred to as a front surface, and the other surface is referred to as a rear surface). The convex portion may be formed in any shape such as a cylindrical shape or a dome shape when seen from the front surface thereof as long as the shape has the above-described protection function. Convex portions 17 are arranged in order that the adjacent convex portions 17 are arranged regularly with a predetermined distance. Therefore, the convex portions 17 may be arranged in a grid pattern on the first spacer members 12 and the second spacer members 13 or the convex portions 17 may be arranged in a zigzag pattern on the first spacer members 12 and the second spacer members 13.

However, as to the convex portions 17, in a part of the first spacer member 12 that the convex portions 17 are supposed to be formed in accordance with the regularity the convex portion 17 is not formed (i.e., the part is a region where the convex portion 17 is supposed to be formed in accordance with the regularity, and a region without the convex portion 17 is referred to as a convex portion non-forming region 12a). Although it will be described in detail later, the convex portion non-forming region is an empty space for arranging a sensor 15 inside the space and is formed by the plurality of convex portions 17 surrounding the convex portion non-forming region 12a in a radial shape on the front surface of the first spacer member 12.

Two first spacer members 12 are arranged to sandwich the stacked electrode body 11 in order that both of the rear surfaces face the stacked electrode body 11. Furthermore, two second spacer members 13 are arranged to sandwich the stacked electrode body 11 in order that both of the rear surfaces face the stacked electrode body 11, and the rear surfaces of two second spacer members 13 are arranged in the direction perpendicular to the rear surface of the first spacer member 12. That is, the battery block is formed by arranging the stacked electrode body 11 in a space surrounded by the four spacers.

In FIG. 4, in order to easily interlock the four spacers, in the first spacer member 12, two concave-shaped notches are formed to the +Y direction from the side positioned to the −Y direction between two sides extending along the Z direction, and two concave-shaped notches are formed to the −Y direction from the side positioned to the +Y direction between the two sides. In the second spacer member 13, convex-shaped protrusions are formed at positions corresponding to the concave-shaped notches. That is, two convex-shaped protrusions protrude to the −X direction from the side positioned to the −X direction between two sides extending along the Z direction, and two convex-shaped protrusions protrude to the +X direction from the side positioned to the +X direction between the two sides. When the concave-shaped notches are respectively fitted to the convex-shaped protrusions, the four spacers may maintain a shape in parallel crosses, and the stacked electrode body 11 is interposed within four sides.

In a case that the concave-shaped notches and the convex-shaped protrusions are not formed, the four spacers are appropriately arranged to contact the stacked electrode body 11, and all spacers are wrapped by an insulating tape or the like to physically connect all the spacers to each other in order to form the battery block. However, when the concave-shaped notches and the convex-shaped protrusions are respectively formed in the corresponding spacers, the battery block may be formed only by fitting the notches and the protrusions to each other. Therefore, the productivity of the battery cell is improved.

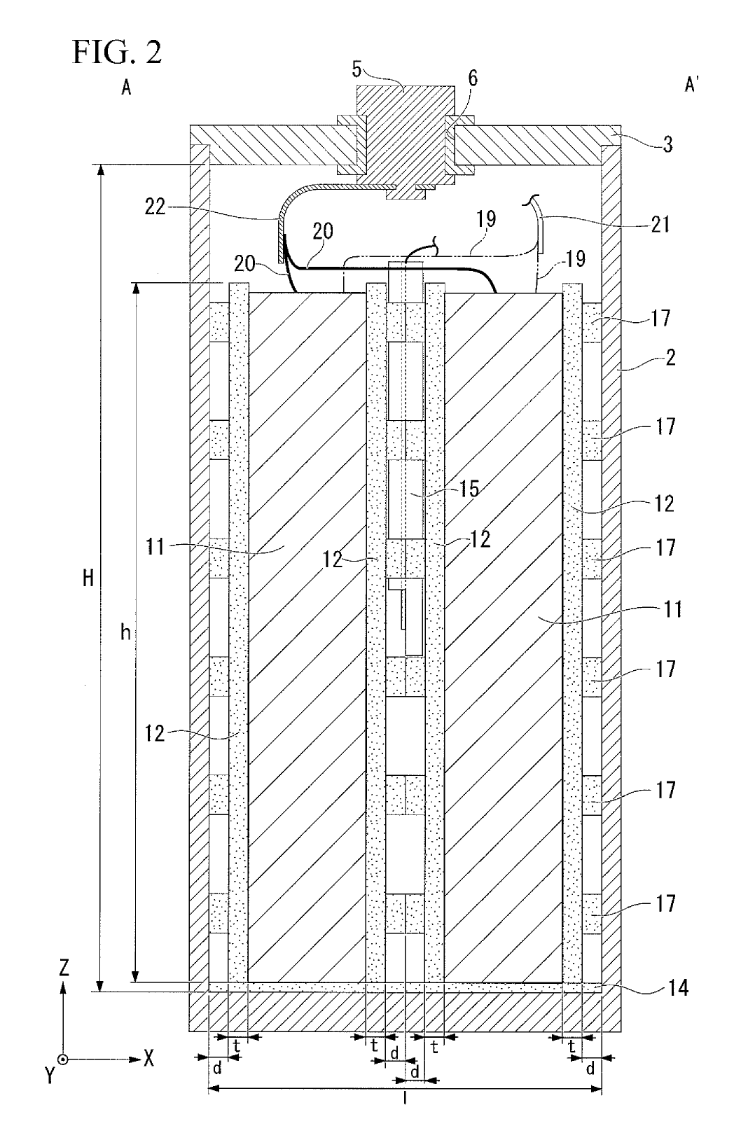

Then, the battery blocks are arranged to form a battery unit (here, a battery unit is configured by arranging the first battery block 9 and the second battery block 10). A buffer material 14 such as an insulating plastic resin (not shown in FIG. 1 for convenience of description and see FIGS. 2 and 3) is laid on the bottom surface of the battery case 2, and the battery unit is inserted into the battery case 2. At this time, because the first spacer member 12 and the second spacer member 13 have the function as an insertion guide, the insertion may be easily performed, and the stacked electrode body 11 is able to be prevented from being damaged during the insertion. Furthermore, the buffer material 14 is arranged to substantially cover the bottom surface. Therefore, even when a vibration is generated in the height direction (Z direction) of the electrical cell 1, a vibration can be softened, which is transmitted to the battery unit installed inside the electrical cell 1.

After or before inserting the battery unit into the battery case 2, the sensor 15 is arranged in a region (hereinafter, referred to as a sensor arrangement region) that includes the convex portion non-forming region 12a and that is formed by the plurality of convex portions 17 surrounding the convex portion non-forming region 12a in a radial shape on the front surface of the first spacer member 12. Because the first battery block 9 and the second battery block 10 form the battery unit by contacting each other's the convex portions 17 of the first spacer members 12, the width of the sensor arrangement region in the stacked direction (i.e., X direction) of the battery block is expressed by “2×d” by using the height “d” of the convex portion (see FIG. 2).

Further, the sensor arrangement region is designed in order that the sensor 15 is arranged and fixed at a predetermined position in the battery case 2 by supporting the outer surface of the sensor 15 with the plurality of convex portions 17. That is, the sensor 15 is supported or held at points of convex portions 17 at least. The sensor 15 is held on the front surface of the first spacer member 12 so as to prevent the sensor 15 from being greatly moved in the battery case 2 even when a vibration or the like is applied to the electrical cell 1. It is possible to prevent the sensor 15 from interruptions the circulation of the electrolyte because of the plurality of convex portions 17. Therefore, the electrical cell 1 may have excellent battery performance Of course, the design may be changed to support the outer surface of the sensor 15 not on a point, but a line by appropriately and continuously connecting the plurality of convex portions 17. The design may be changed in order that the outer surface of the sensor 15 is supported by a combination of a point and a line, which is not simply the line.

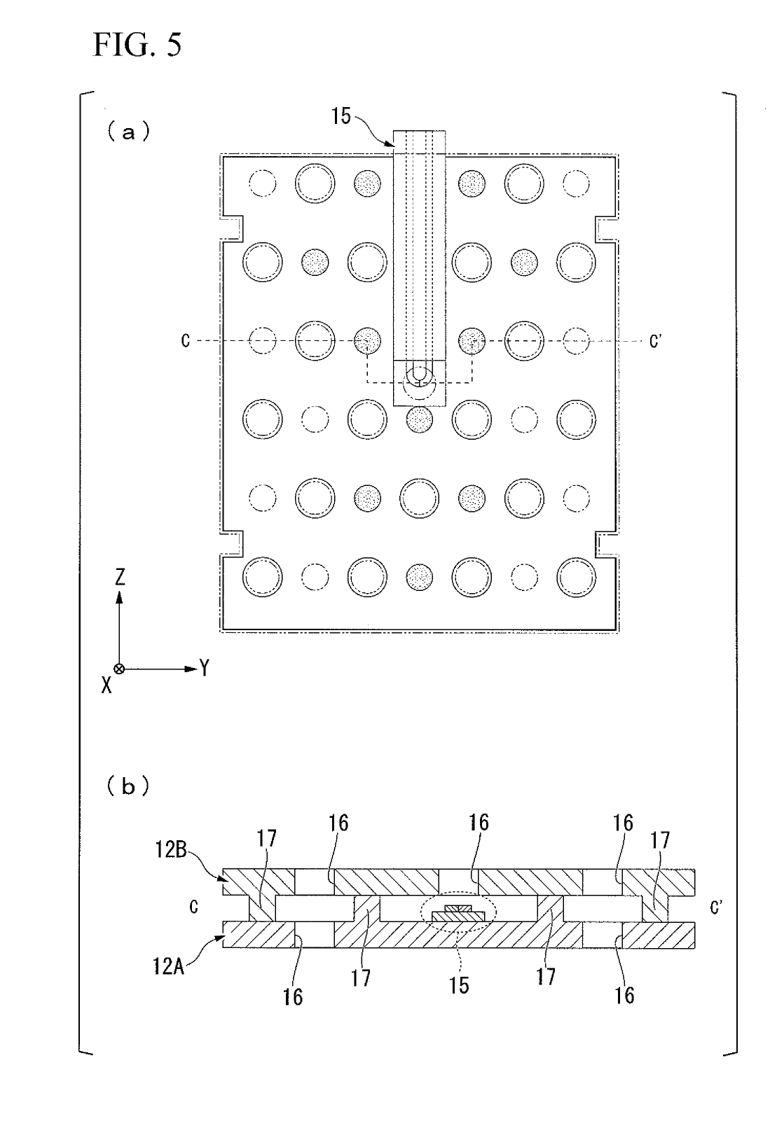

Furthermore, although the two first spacer members 12 have the same size, they may not have the same size as long as the spacers are arranged at a contact portion between two battery blocks to form the sensor arrangement region. FIGS. 5(a) and 5(b) illustrate an example in which two types of spacers 12A and 12B corresponding to the first spacer member 12 are set to sandwich the battery block and in which two battery blocks sandwiched by the spacers 12A and 12B are arranged in a line (because the other components are the same as those of FIG. 1 the description thereof will not be repeated).

The spacers 12A and 12B have the same size as that of the first spacer member 12 as shown in FIG. 5(a), but the plurality of convex portions 17 thereof are not formed in the same pattern as shown in FIG. 5(b) as the cross-sectional view (the cross-sectional view of the spacers at the position where two battery blocks contact each other through the spacers) on the XY plane with taken along the line C-C′ of FIG. 5(a). The convex portions 17 of the spacer 12A and the convex portions 17 of the spacer 12B are designed not to overlap each other during overlapping the spacers 12A and 12B. Therefore, in this case, the width of the sensor arrangement region is equal to the height “d” of the convex portion 17. Because the width of the sensor arrangement region is set to be small as compared with the battery cell in FIG. 4 having two first spacer members 12, a decrease in size of the electrical cell may be promoted in addition to the above-described effect.

Further, here, the sensor 15 is described as the temperature sensor so as to measure the temperature generated between the battery blocks installed inside the battery case 2. However, the sensor may be a pressure sensor in a case to measure a pressure generated between the battery blocks. The type of the sensor 15 may be appropriately changed in accordance with parameters to be measured, such as temperature and pressure generated inside the electrical cell 1. Further, when the sensor is small and is not easily held in the sensor arrangement region, the sensor 15 may be formed by putting the body of the sensor in a sensor case 15A. Therefore, the outer surface of the sensor case 15A is held in the sensor arrangement region.

In the electrical cell 1 of the embodiment, because the body of the sensor is a thermocouple as a temperature sensor, as shown in FIGS. 1 to 4, the thermocouple is put in the sensor case 15A. The thermocouple is configured by bonding different types of metal to each other. When the temperature is measured by the thermocouple, an interconnection 15a and an interconnection 15b respectively bonded to different types of metal are extracted to the outside of the electrical cell 1, in order that the interconnections are connected to a voltmeter 23 outside the electrical cell 1. Therefore, two interconnections 15a and 15b are bound to each other and are integrated with the sealing member 8. With this configuration, the interconnections may be extracted from the liquid injecting hole 7, a liquid may be injected therethrough, and the electrical cell 1 is substantially and perfectly sealed by the sealing member 8.

Furthermore, the stacked electrode body 11 may be formed by stacking a plurality of positive electrode plates and a plurality of negative electrode plates with each corresponding separator (stacked-type electrode body), or formed by stacking one positive electrode plate and one negative electrode plate with one separator interposed between them and by rolling up the electrode plates and the separator (wound-type electrode body).

Although not in FIGS. 1 and 4, as in FIGS. 2 and 3, the stacked electrode body 11 has a positive electrode tab 19 extending from the positive electrode plate and a negative electrode tab 20 extending from the negative electrode plate, and they are respectively electrically connected to the corresponding positive electrode terminal 4 or the corresponding negative electrode terminal 5 through a positive electrode lead 21 or a negative electrode lead 22.

The thickness (in the X direction) of the stacked electrode body 11 is designed in order that the battery unit is not greatly moved in the battery case 2 even when a vibration or the like is applied to the electrical cell 1. Here, since one battery unit includes two battery blocks, the thickness (in the X direction) of the stacked electrode body 11 is designed to satisfy an equation of “(1−((4×d)+(4×t))/2”. In the equation, “1” corresponds to lower-case letter of “L”.

The height (in the Z direction) of the stacked electrode body 11 is designed so as to be substantially equal to or smaller than the height “h” of the spacer in order that the stacked electrode body is reliably sandwiched by between the first spacer members 12 and the second spacer members 13. The height “h” of the spacer is designed to be substantially equal to or slightly smaller than the dimension “H” in the height direction (Z direction) of the electrical cell 1.

With the above-described configuration, in the electrical cell of the embodiment, the sensor measures the temperature near the center portion inside the electrical cell, because the center portion becomes the hottest during charging and discharging the lithium secondary battery. At this time, because the sensor is set in the sensor arrangement region formed by the spacers arranged between the battery blocks, it is possible to provide the electrical cell capable of having satisfactory battery performance while preventing deformation or damage of the electrode plate.

### Second Embodiment

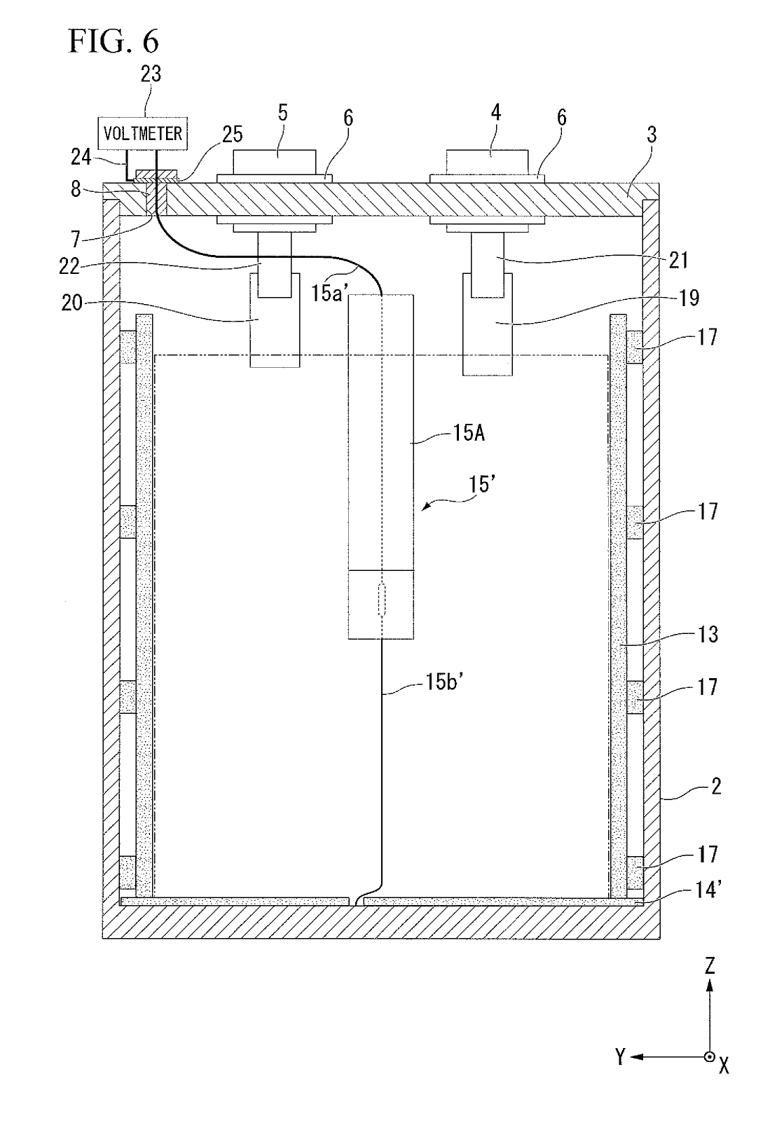

Next, an electrical cell of a second embodiment will be described by referring to FIG. 6. The electrical cell of the second embodiment is different from the electrical cell of the first embodiment as below. In the first embodiment, two interconnections 15a and 15b of the sensor 15 are all extracted from the liquid injecting hole 7. However, in the second embodiment, only one interconnection is extracted from the liquid injecting hole 7, and the other interconnection is not extracted. Because the other configurations are the same as those of the electrical cell of the first embodiment, the same reference numerals are given to the same components as those of the first embodiment, and the description thereof will not be repeated here.

In the electrical cell of the second embodiment, the battery case 2 and the cover 3 are all formed of a conductive material, which is, for example, metal. An interconnection 15a′ of two interconnections 15a′ and 15b′ extending from a sensor 15′ is extracted to the outside of the electrical cell and is connected to the voltmeter 23 as in the electrical cell of the first embodiment.

Regarding the interconnection 15b′, a buffer material 14′ is arranged on the bottom of the battery case 2 in order that the interconnection 15b′ passes through the buffer material 14′, which is the same as the buffer material 14 except that the buffer material 14 has a through-hole for the interconnection 15b′, prior to inserting the battery unit into the battery case 2. Accordingly, the interconnection 15b′ is interposed between the battery case 2 and the buffer material 14′, and contacts the battery case 2. And when the battery unit is inserted into the battery case 2, the interconnection 15b′ and the battery case 2 more strongly come into contact with each other due to the weight thereof.

A metal terminal 25 is arranged between the sealing member 8 and the battery case 2, and the interconnection 24 connected to the metal terminal 25 is connected to the voltmeter 23. Therefore, the voltage of the sensor 15′ is measured (i.e., a temperature is measured using the voltage). That is, in this case, because the battery case 2 and the cover 3 are formed of a conductive material, they substantially work as an interconnection or a wire. With this configuration, even when the liquid injecting hole 7 is small and both interconnections of the sensor installed inside the electrical cell are not easily drawn to the outside of the electrical cell through the liquid injecting hole 7, the sensor is able to be appropriately arranged. Therefore, the electrical cell is able to be decreased in size.

Furthermore, the sensor of the embodiment may be the same as that of the first embodiment. Because the battery case 2 can be used as the interconnection or the wire, for example, in a case that the temperature of the battery cell needs to be measured precisely temperature sensor, the sensor 15′ may be a fuse causing disconnection due to a predetermined temperature. That is, it is possible to measure the predetermined temperature precisely because the voltmeter 23 only measures whether electrical disconnection occurs or not.

In the electrical cell of the first and the second embodiments, an example has been described in which the electrical cell includes two battery blocks, but the number of the battery blocks included in the electrical cell may be three or more. When the electrical cell includes three or more battery blocks, the sensor may be arranged in any gap formed by the spacers between the plurality of adjacent battery blocks, or the sensor may be arranged between the specific battery blocks.

Further, a configuration is shown in which the interconnection connected to the sensor is drawn to the outside, but the interconnection may not be drawn from the sensor to the outside of the electrical cell. The measurement information may be wirelessly transmitted from the sensor to the outside of the electrical cell by using a wireless device installed inside the sensor, or the history of the measurement information may be obtained when the electrical cell is taken apart to pieces for the first time.

Furthermore, an example has been described in which the electrical cell of the above-described embodiments is the lithium ion secondary battery cell, but the invention may be applied to an electrical cell of any battery of a primary battery or a secondary battery.

While preferred embodiments of the invention have been described and illustrated above, it should be understood that these are exemplary of the invention and are not to be considered as limiting. Additions, omissions, substitutions, and other modifications can be made without departing from the substance or scope of the present invention. Accordingly, the invention is not to be considered as being limited by the foregoing description, and is only limited by the scope of the appended claims.

### BRIEF DESCRIPTION OF THE REFERENCE SYMBOLS

1: electrical cell
2: battery case
4: positive electrode terminal
5: negative electrode terminal
9: first battery block
10: second battery block
11: stacked electrode body
12: first spacer member (first spacer and second spacer)
13: second spacer member (third spacer and forth spacer)
15: sensor
15a, 15a′: first interconnection
15b, 15b′: second interconnection
17: convex portion
24: interconnection

What is claimed is:

1. An electrical cell comprising:
a first battery block including a first stacked electrode body formed by stacking a positive electrode plate and a negative electrode plate through a separator and a first spacer arranged on the first stacked electrode body;
a second battery block including a second stacked electrode body formed by stacking a positive electrode plate and a negative electrode plate through a separator and a second spacer arranged on the second stacked electrode body;
a battery case containing the first battery block and the second battery block to contact the first spacer and the second spacer; and
a sensor,
wherein the sensor is arranged in a sensor arrangement region formed between the first spacer and the second spacer.

2. The electrical cell according to claim 1,
wherein a plurality of convex portions is formed on a surface of the first spacer or the second spacer, and
wherein a part of the outer surface of the sensor arranged in the sensor arrangement region is substantially supported and held in at least at points by the plurality of convex portions.

3. The electrical cell according to claim 2,
wherein the first battery block is formed by interposing the first stacked electrode body between two first spacers, and
wherein the second battery block is configured by interposing the second stacked electrode body between two of the second spacer.

4. The electrical cell according to claim 3,
wherein the first battery block further includes two third spacers that surround the first stacked electrode body with two of the first spacer with a parallel cross shape, and
wherein the second battery block further includes two fourth spacers that surround the second stacked electrode body with two of the second spacer with a parallel cross shape.

5. The electrical cell according to any one of claims 2,
wherein a part of the outer surface of the sensor arranged in the sensor arrangement region is supported and held by at least a line.

6. The electrical cell according to any one of claims 3,
wherein a part of the outer surface of the sensor arranged in the sensor arrangement region is supported and held by at least a line.

7. The electrical cell according to any one of claims 4,
wherein a part of the outer surface of the sensor arranged in the sensor arrangement region is supported and held by at least a line.

8. The electrical cell according to claim 5,
wherein the first stacked electrode body and the second stacked electrode body are a stacked type,
wherein the first spacer and the second spacer have substantially the same structure or the same size,
wherein the third spacer and the fourth spacer have substantially the same structure or the same size, and
wherein the sensor is a temperature sensor.

9. The electrical cell according to claim 6,
wherein the first stacked electrode body and the second stacked electrode body are a stacked type,
wherein the first spacer and the second spacer have substantially the same structure or the same size,
wherein the third spacer and the fourth spacer have substantially the same structure or the same size, and
wherein the sensor is a temperature sensor.

10. The electrical cell according to claim 7,
wherein the first stacked electrode body and the second stacked electrode body are a stacked type,
wherein the first spacer and the second spacer have substantially the same structure or the same size,
wherein the third spacer and the fourth spacer have substantially the same structure or the same size, and
wherein the sensor is a temperature sensor.

11. The electrical cell according to any one of claims 2,
wherein the battery case has conductivity,
wherein the sensor includes two interconnections, and
wherein one of the interconnections is electrically connected to the battery case.

12. The electrical cell according to any one of claims 3,
wherein the battery case has conductivity,
wherein the sensor includes two interconnections, and
wherein one of the interconnections is electrically connected to the battery case.

13. The electrical cell according to any one of claims 4,
wherein the battery case has conductivity,
wherein the sensor includes two interconnections, and
wherein one of the interconnections is electrically connected to the battery case.
